(19) United States
(12) Patent Application Publication
(10) Pub. No.: US 2021/0177035 A1
(43) Pub. Date: Jun. 17, 2021

(54) FLAVOUR COMPOSITION

(71) Applicant: Givaudan SA, VERNIER (CH)

(72) Inventors: Guiseppe CORDA, Lelystad (NL); Aloysius Lambertus DOORN, Zeewolde (NL); Frans WITTEVEEN, Leusden (NL)

(21) Appl. No.: 17/262,720

(22) PCT Filed: Aug. 26, 2019
(86) PCT No.: PCT/EP2019/072669

§ 371 Date: Jan. 23, 2021

(30) Foreign Application Priority Data
Aug. 27, 2018 (GB) 1813912.1

(51) Int. Cl. A23P 10/20; A23L 27/21; A23L 29/30; A23L 27/10; A23L 27/26; A23L 27/00

(52) U.S. Cl. CPC A23P 10/20; A23L 27/215; A23L 29/35; A23V 2002/00; A23L 27/105; A23L 27/26; A23L 27/70; A23L 27/10

(57) ABSTRACT

A solid flavour composition includes a plurality of individual components at least one of which is a flavour-providing substance and at least one of which is an auxiliary ingredient, in which all amorphous components are present as particulate aggregates. The flavour composition is particularly storage-stable.

This disclosure relates to solid flavour compositions and to products containing such compositions.

Many comestible compositions contain added flavours. The added flavours can be individual flavour-providing substances, but more commonly these substances are added as part of flavour composition, which comprises other components in addition to the flavour. This is done in order to, among other things, provide better flavouring and preserve and protect the flavour-providing substance until its effect is required. (Naturally, there may be present more than one flavour-providing substance and the use of the singular in this description also includes the plural). Examples of typical additional components of flavour compositions include crystalline food additives to provide sweet, salty, acid or umami taste. Typical flavour compositions may be prepared by simple mixing of the desired ingredients.

It is well understood that, not only should such compositions deliver flavour, but also that they should be stable under storage or transport. This is often not the case, and it has been found that, under conditions of extended storage, flavour compositions that are mixtures start to cake or clump, making them difficult to use and necessitating their break-up prior to use, all of which is undesirable in the production of flavoured comestible compositions.

It has now been found that it is possible to prepare solid flavour compositions whose tendency to clump or cake on storage is considerably reduced or even completely eliminated. There is therefore provided a solid flavour composition, comprising a plurality of individual components at least one of which is a flavour-providing substance and at least one of which is an auxiliary ingredient, in which all amorphous components are present as particulate aggregates.

There is additionally provided a method of preparing a solid flavour composition comprising a plurality of individual components, at least one of which is a flavour-providing substance and at least one of which is an auxiliary component, comprising the formation of particulate aggregates of all amorphous components, followed by the blending of the aggregates with the remaining components.

By “amorphous” is meant any component that does not exist as a crystalline material at room temperature (25° C.), that is, it lacks the extended, ordered structure typical of a crystalline material. The concepts of “amorphous” and “crystalline” as applied to the components of flavour compositions are well understood, and the skilled person will know which component will fall into which category.

By “flavour-providing substance” is meant any substance whose primary function is to provide flavour. More than one such substance may be present. There are many such substances available to the art, typical examples including flavours to provide umami taste, such as yeast and/or Maillard reaction flavours. Other typical examples include flavour components to provide savoury taste such as tomato, onion, meaty, basil and spiciness.

By “auxiliary ingredient” is meant any component of the flavour composition whose primary purpose is other than providing flavour. Typical reasons for the addition of such ingredients include the provision of cohesion to form a suitable agglomerate, improving the stability for extended storage, reducing or avoiding caking of the agglomerate, promoting flowability and enhancing taste perception. Typical examples of such ingredients include dextrin and starches and hydrocolloids such as gum arabic and xanthan gum.

The aggregates may be prepared by any convenient means, for example, by blending together the amorphous components, followed by any suitable type of granulation, such as fluidized bed or rotor granulation.

The agglomerates containing the amorphous ingredients show better anti-caking behavior. They also promote enhanced flowability behavior for any flavor composition in which they are incorporated.

The disclosure is further described with reference to the following non-limiting example.

Test flavours were prepared from the following components—the underlined components are amorphous:

| Umami flavour¹ | 90 parts (wt) |
|---|---|
| Process flavour² | 60 |
| Yeast | 44 |
| Salt enhancer³ | 8 |
| Lactic acid | 216 |
| Maltodextrin filler⁴ | 50 |
| Salt | 500 |
| Sodium diacetate | 400 |
| Dextrose | 14 |
| Sugar | 266 |
| Citric acid | 250 |

¹Umami 501, ex Biorigin Europe, Belgium
²Koqumex ™ Maillard reaction process flavour
³N-Lactoyl Ethanolamine
⁴Eliane ™ MD6 (ex Avebe, Netherlands), a modified potato starch, was used

In one embodiment, the entire formulation was blended in a Ruberg blender to give a particulate flavour (“FlavourA”).

In a separate preparation, the amorphous components were separately granulated using a Glatt Rotor granulator and then blended with the crystalline components (“Flavour B”).

Samples of both flavours were placed in open cups and stored in a desiccator at 25° C. at different water activity (a_{w}) levels. The samples were checked by an expert panel after 24, 40, 46, 64,136, 160, 184, 208, 232 and 304 hours. The results are shown in the following tables, in which
1=powdery, no change from original
2=some slight caking observed
3=caked solid
4=rubbery (consistency like chewing gum)

a_{w}=0.11

| Time (h) | 24 | 40 | 46 | 64 | 136 | 160 | 184 | 208 | 232 | 304 |
|---|---|---|---|---|---|---|---|---|---|---|
| Flavour A | 1 | 1 | 1 | 1 | 1 | 1 | 1 | 1 | 1 | 1 |
| Flavour B | 1 | 1 | 1 | 1 | 1 | 1 | 1 | 1 | 1 | 1 |

a_{w}=0.23

| Time (h) | 24 | 40 | 46 | 64 | 136 | 160 | 184 | 208 | 232 | 304 |
|---|---|---|---|---|---|---|---|---|---|---|
| Flavour A | 1 | 1 | 1 | 1 | 1 | 1 | 1 | 1 | 1 | 1 |
| Flavour B | 1 | 1 | 1 | 1 | 1 | 1 | 1 | 1 | 1 | 1 |

a_{w}=0.33

| Time (h) | 24 | 40 | 46 | 64 | 136 | 160 | 184 | 208 | 232 | 304 |
|---|---|---|---|---|---|---|---|---|---|---|
| Flavour A | 2 | 2 | 2 | 2 | 2 | 2 | 2 | 2 | 2 | 2 |
| Flavour B | 1 | 1 | 1 | 1 | 1 | 1 | 1 | 1 | 1 | 1 |

a_{w}=0.43

| Time (h) | 24 | 40 | 46 | 64 | 136 | 160 | 184 | 208 | 232 | 304 |
|---|---|---|---|---|---|---|---|---|---|---|
| Flavour A | 3 | 3 | 3 | 3 | 3 | 3 | 3 | 3 | 3 | 3 |
| Flavour B | 1 | 2 | 2 | 2 | 2 | 4 | 4 | 4 | 4 | 4 |

It is clear that, over time and in higher aw conditions, the separated components Flavour B is the better performer.

This was further demonstrated by exposing the two samples to 30° C. and 40% humidity (a_{w}=0.4) in a Weiss climate testing chamber. The results were as follows:

| Time (h) | 2 | 4 | 6 | 24 | 48 | 72 |
|---|---|---|---|---|---|---|
| Flavour A | 4 | 3 | 3 | 3 | 3 | 3 |
| Flavour B | 1 | 2 | 2 | 4 | 4 | 4 |

1. A solid flavour composition comprising a plurality of individual components at least one of which is a flavour-providing substance and at least one of which is an auxiliary ingredient, in which all amorphous components are present as particulate aggregates.

2. A method of preparing a solid flavour composition comprising a plurality of individual components, at least one of which is a flavour-providing substance and at least one of which is an auxiliary component, comprising the formation of particulate aggregates of all amorphous components, followed by the blending of the aggregates with the remaining components.

3. The solid flavour composition of claim 1, comprising more than one flavour-providing substance.

4. The solid flavour composition of claim 1, wherein the flavour-providing substance provides a umami taste.

5. The solid flavour composition of claim 1, wherein the flavour-providing substance comprises process flavour.

6. The solid flavour composition of claim 5, wherein the process flavour comprises a Maillard reaction flavour.

7. The solid flavour composition of claim 1, wherein the flavour-providing substance provides a savoury taste.

8. The solid flavour composition of claim 7, wherein the savoury taste is selected from tomato, onion, meaty, basil and spiciness.

9. The solid flavour composition of claim 1, wherein the auxiliary ingredient is selected from dextrin, starches, and hydrocolloids.

10. The solid flavour composition of claim 1, wherein the auxiliary ingredient provides cohesion to form agglomerates.

11. The solid flavour composition of claim 1, wherein the auxiliary ingredient reduces caking of agglomerates.

12. The solid flavour composition of claim 1, wherein the auxiliary ingredient provides improved stability for extended storage of the composition.

13. The solid flavour composition of claim 1, wherein the auxiliary ingredient promotes flowability of the composition.

14. The solid flavour composition of claim 1, wherein the composition is powdery after storage in a desiccator at 25° C. at a water activity level (a_{w}) of 0.11 for 24, 40, 46, 64, 136, 160, 184, 208, 232 and 304 hours.

15. The solid flavour composition of claim 1, wherein the composition is powdery after storage in a desiccator at 25° C. at a water activity level (a_{w}) of 0.23 for 24, 40, 46, 64, 136, 160, 184, 208, 232 and 304 hours.

16. The solid flavour composition of claim 1, wherein the composition is powdery after storage in a desiccator at 25° C. at a water activity level (a_{w}) of 0.33 for 24, 40, 46, 64, 136, 160, 184, 208, 232 and 304 hours.

17. The solid flavour composition of claim 1, wherein the composition is powdery after storage in a desiccator at 25° C. at a water activity level (a_{w}) of 0.43 for 24 hours.
